(19) United States
(12) Patent Application Publication
(10) Pub. No.: US 2012/0096502 A1
(43) Pub. Date: Apr. 19, 2012

(54) APPARATUS AND METHOD FOR DISTRIBUTING INTEGRATED BROADCAST

(75) Inventors: Byung-Ho YAE, Daejeon (KR); Jong-Dae Park, Daejeon (KR)

(73) Assignee: Electronics and Telecommunications Research Institute, Daejeon (KR)

(21) Appl. No.: 13/275,758

(22) Filed: Oct. 18, 2011

(30) Foreign Application Priority Data
Oct. 18, 2010 (KR) 10-2010-0101462

(51) Int. Cl. H04N 7/173

(52) U.S. Cl. 725/108

(57) ABSTRACT

An integrated broadcast distributing apparatus and method capable of obtaining integrated broadcast including Cable Television (CATV) broadcast, Internet Protocol Television (IPTV) broadcast and real time terrestrial broadcast is provided. The apparatus includes a broadcast receiving unit configured to receive a plurality of pieces of broadcast information about the plurality of broadcasts, a channel information managing unit configured to check an existence of a plurality of subscriber terminals of the subscriber terminals requesting a same real time broadcast channel of the plurality of broadcasts, and a broadcast distribution unit configured to copy broadcast information corresponding to the same real time broadcast channel and distribute the copied broadcast information corresponding to the same real time broadcast channel to the subscriber terminals requesting the same real time broadcast channel, if a result of the checking is that a plurality of subscriber terminals requesting the same real time broadcast channel exist.

### CROSS-REFERENCE TO RELATED APPLICATION

This application claims the benefit under 35 U.S.C. §119(a) of Korean Patent Application No. 10-2010-0101462, filed on Oct. 18, 2010, the disclosure of which is incorporated by reference in its entirety for all purposes.

### BACKGROUND

1. Field

The following description relates to an apparatus and method for distributing integrated broadcast for a smart television, and more particularly, to an apparatus and method for distributing integrated broadcast capable of providing Cable Television (CATV) broadcast, Internet Protocol Television (IPTV) broadcast and real time terrestrial broadcast.

2. Description of the Related Art

Broadcasting services are provided through various ways of transmission, such as Cable Television broadcast (hereinafter, referred to as CATV broadcast), terrestrial broadcast and internet protocol television broadcast (hereinafter, referred to as IPTV broadcast). In order for a user to receive those various broadcasting services, the user needs to change a broadcasting service provider or additionally install equipment, such as a set top box, thereby increasing the cost in receiving broadcasting services and degrading space utilization.

In addition, in order for a subscriber terminal to watch various channels, lines for CATV and IPTV services need to additionally installed. However, an apartment building has a fixed number of lines installed thereon, causing a difficulty in installing lines of service providers more than a limited number of lines that are assigned to one subscriber. Such a restriction may reduce the user's desire to receive more various services. In addition, the real time terrestrial broadcast is able to be transmitted through a CATV network and an IPTV network, resulting in transmission delay and degrading the quality of services. In this case, the internet bandwidth of the IPTV may be wasted.

### SUMMARY

In one aspect, there is provided an apparatus and method for distributing integrated broadcast, enabling a user terminal to have CATV broadcasts, IPTV broadcasts and real time terrestrial TV broadcasts and capable of saving the bandwidth by reducing traffic load in a network.

In one general aspect, there is provided an integrated broadcast distributing apparatus for distributing a plurality of broadcasts, which are received from a plurality of broadcast providers, to subscriber terminals, the apparatus including: a broadcast receiving unit configured to receive a plurality of pieces of broadcast information about the plurality of broadcasts; a channel information managing unit configured to check an existence of a plurality of subscriber terminals of the subscriber terminals requesting a same real time broadcast channel of the plurality of broadcasts; and a broadcast distribution unit configured to copy broadcast information corresponding to the same real time broadcast channel and distribute the copied broadcast information corresponding to the same real time broadcast channel to the subscriber terminals requesting the same real time broadcast channel, if a result of the checking is that the plurality of subscriber terminals requesting the same real time broadcast channel exist.

In another general aspect, there is provided an integrated broadcast distributing method for distributing a plurality of broadcasts received from a plurality of broadcast providers to subscriber terminals, the method including: receiving broadcast information about the plurality of broadcasts; checking an existence of real time broadcast channels in the plurality of broadcasts; checking an existence of a plurality of subscriber terminals of the subscriber terminals requesting a same real time broadcast channel of the checked real time broadcast channels; and copying broadcast information corresponding to the same real time broadcast channel and distributing the copied broadcast information corresponding to the same real time broadcast channel to the subscriber terminals requesting the same real time broadcast channel, if it is checked that the plurality of subscriber terminals requesting the same real time broadcast channel exist.

In another general aspect, there is provided an integrated broadcast distributing method for distributing a plurality of broadcasts received from a plurality of broadcast providers to a plurality of subscriber terminals, the method including: receiving cable television (CATV) broadcast information; converting the CATV broadcast information to a broadcast packet in the form of an Internet Protocol (IP) packet; determining a first subscriber terminal, which has requested the CATV broadcast information, by searching subscriber channel information including current channel information representing a broadcast channel, which is being watched or is requested for watching, at each of the subscriber terminals; transmitting the broadcast packet to the determined first subscriber terminal; searching to determine whether a second subscriber terminal, which has requested the CATV broadcast information, exists, if the received CATV broadcast information is broadcast information corresponding to a real time broadcast channel; copying the broadcast packet if a result of the searching is that the second subscriber terminal having requested the CATV broadcast information exists; and transmitting the copied broadcast packet to the second subscriber terminal.

In another general aspect, there is provided an integrated broadcast distributing method for distributing a plurality of broadcasts received from a plurality of broadcast providers to a plurality of subscriber terminals, the method including: receiving Internet Protocol television (IPTV) broadcast information; determining a first subscriber terminal, which has requested IPTV broadcast information, by searching subscriber channel information including current channel information that represents a broadcast channel which is being watched or is requested for watching at each of the subscriber terminals; transmitting the IPTV broadcast information to the determined first subscriber terminal; searching to determine whether a second subscriber terminal, which has requested the IPTV broadcast information, exists, if the received IPTV broadcast information is broadcast information about a real time broadcast channel; copying the IPTV broadcast information if a result of the searching is that the second subscriber terminal having requested the IPTV broadcast information exists; and transmitting the copied IPTV broadcast information to the second subscriber terminal.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a diagram illustrating an example of a network system in which a terrestrial broadcast, a CATV broadcast and an IPTV broadcast are distributed to a plurality of subscriber terminals in an integrated manner.

FIG. 2 is a diagram illustrating an example of the configuration of an apparatus for distributing integrated broadcast.

FIG. 3 is a diagram illustrating an example of the configuration of channel state information that is managed by a channel information manager of FIG. 2.

FIG. 4 is a diagram illustrating an example of the configuration of subscriber channel information that is managed by the channel information manager of FIG. 3.

FIG. 5 is a flowchart illustrating an example of the control flow of a method for distributing integrated broadcast.

FIG. 6 is a flowchart illustrating an example of the operation of the integrated broadcast distributing apparatus upon reception of a request for channel by a subscriber terminal.

FIG. 7 is a flowchart illustrating an example of a process in which broadcast information is received from a CATV broadcast provider and the received broadcast information is provided to a subscriber terminal.

FIG. 8 is a diagram illustrating an example of a process in which broadcast information is received from a IPTV broadcast provider and the received broadcast information is provided to a subscriber terminal.

FIG. 9 is a diagram illustrating an example of a process in which broadcast information is to received from a terrestrial provider and the received broadcast information is provided to a subscriber terminal.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

Hereinafter, examples will be described with reference to accompanying drawings in detail.

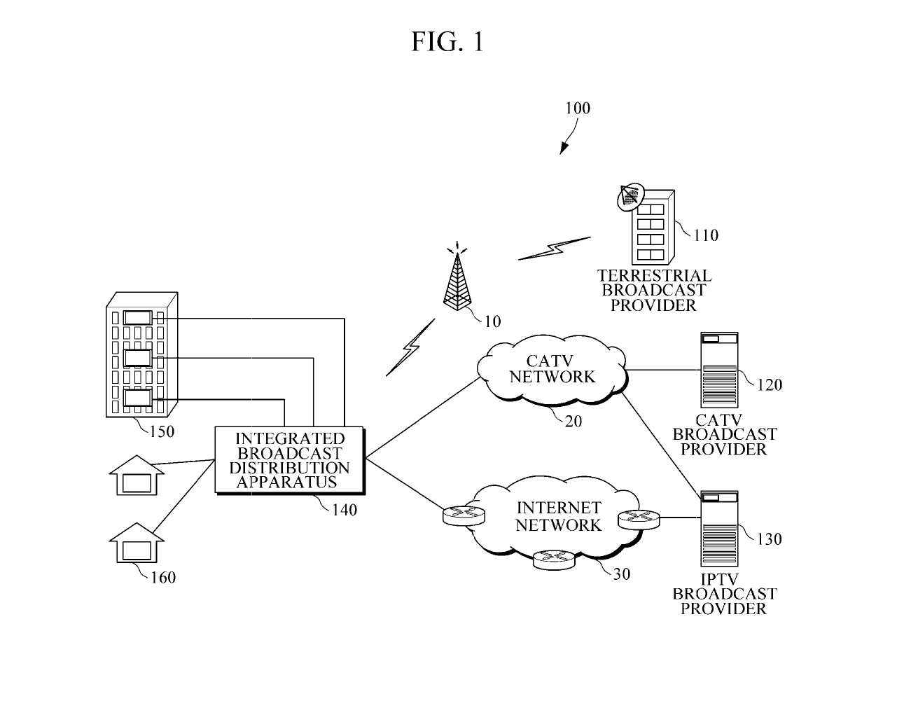

FIG. 1 is a diagram illustrating an example of a network system in which a terrestrial broadcast, a CATV broadcast and an IPTV broadcast are distributed to a plurality of subscriber terminals in an integrated manner.

Referring to FIG. 1, a network system 100 includes a terrestrial broadcast network 10, a cable television (CATV) network 20, an internet network 30, broadcast service providers including a terrestrial broadcast provider 110, a CATV broadcast provider 120 and an IPTV broadcast provider 130, an integrated broadcast distribution apparatus 140 and subscriber terminals 150 and 160. The broadcast represents a one-way broadcast, which is transmitted through the terrestrial broadcast network 10 and the CATV network 20, and a two-way broadcast, such as a VOD service and a data service, which is transmitted through the CATV network 20 and the internet network 30.

The terrestrial broadcast provider 110 transmits broadcast information to the integrated broadcast distribution apparatus 140 through the terrestrial broadcast network 10 including a repeater. The CATV broadcast provider 120 transmits broadcast information to the integrated broadcast distribution apparatus 140 through the CATV network 20. The IPTV broadcast provider 130 transmits broadcast information to the integrated broadcast distribution apparatus 140 through the IPTV network 30. A single broadcast service provider may serve as both of the CATV broadcast provider 120 and the IPTV broadcast provider 130. The IPTV broadcast may be transmitted to the integrated broadcast distribution apparatus 140 through the CATV network 20. The network system 10 may include a plurality of terrestrial broadcast providers 110, a plurality of CATV broadcast providers 120 and a plurality of IPTV broadcast providers 130.

The integrated broadcast distribution apparatus 140 distributes broadcasts, which are received from a plurality of broadcast providers including the terrestrial broadcast provider 110, the CATV broadcast provider 120 and the IPTV broadcast provider 130, to a plurality of subscriber terminals 150 and 160 in an integrated manner. The subscriber terminal 150 may represent a subscriber terminal of a private house, and the subscriber 160 may represent a subscriber terminal of a public house.

The integrated broadcast distribution apparatus 140 may be connected to the subscriber terminals 150 and 160 through a wired/wireless IP network. Accordingly, even if a CATV line and a CATV set top box are not installed or the terrestrial broadcast reception function is not provided, the subscriber terminals 150 and 160 may receive the terrestrial broadcast, the CATV broadcast and the IPTV broadcast in an integrated manner by use of the integrated broadcast distribution apparatus 140. The subscriber terminals 150 and 160 may be a smart television. The subscriber terminal may be implemented in various forms of electronic devices capable of receiving various contents and data services through an IP network.

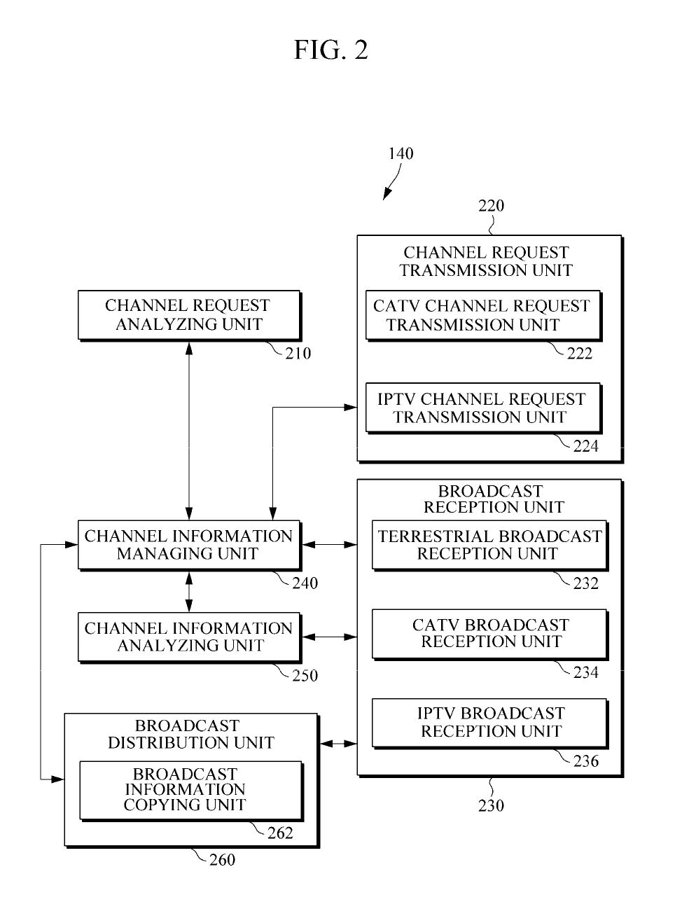

FIG. 2 is a diagram illustrating an example of the configuration of an apparatus for distributing integrated broadcasts.

The integrated broadcast distribution apparatus 140 may include a channel request analyzing unit 210, a channel request transmission unit 220, a broadcast reception unit 230, a channel information managing unit 240, a channel information analyzing unit 250 and a broadcast distribution unit 260.

The channel request analyzing unit 210 receives channel request information from a plurality of subscriber terminals, which receive broadcast services through the integrated broadcast distribution apparatus 140, and analyses the received channel request information. The channel request analyzing unit 210 analyzes which subscriber terminal requests which broadcast channel among the terrestrial broadcast, the IPTV broadcast and the CATV broadcast, and transmits the result of analysis to the channel information managing unit 240.

The channel request transmission unit 220 includes a CATV channel request transmission unit 222 and an IPTV channel request transmission unit 224, and transmits CATV channel request information or IPTV channel request information to the CATV broadcast provider 120 or the IPTV broadcast provider 130. If the requested channel is not currently providing services or the registered channel is a VOD service or a data service, the CATV channel request transmission unit 222 and the IPTV channel request unit 224 request a CATV broadcast channel or an IPTV broadcast channel. The channel request transmission unit 220 may be controlled by the channel information managing unit 240.

The broadcast receiving unit 230 receives a plurality of pieces of broadcast information from a plurality of broadcast providers, such as the terrestrial broadcast provider 110, the CATV broadcast provider 120 and the IPTV broadcast provider 130. The broadcast reception unit 230 may include a terrestrial broadcast reception unit 232, a CATV broadcast reception unit 234 and an IPTV broadcast reception unit 236. The terrestrial broadcast reception unit 232 is configured to receive a terrestrial broadcast from the terrestrial broadcast provider 110, process the received terrestrial broadcast, and generate meta information, which is related to a broadcast channel, and broadcast information, which represents broadcast content, by use of the processed terrestrial broadcast. The terrestrial broadcast reception unit 232 receives and processes at least one terrestrial broadcast, which is requested by the subscriber terminals 150 and 160, among a plurality of terrestrial broadcasts being received. The CATV broadcast reception unit 234 is configured to receive broadcast information from the CATV broadcast provider 120 and processes the received broadcast information. The IPTV broadcast reception unit 236 is configured to receive broadcast information from the IPTV broadcast provider 130 and process the received broadcast information.

The channel information managing unit 240 may be connected to the channel request analyzing unit 210, the channel request transmission unit 220, the broadcast reception unit 230, the channel information analyzing unit 250 and the broadcast distribution unit 260 to control the overall operations of the integrated broadcast distribution apparatus 140. The channel information managing unit 240 is configured to check the existence a plurality of subscriber terminals watching the same real time broadcast channel in a plurality of broadcasts.

The channel information managing unit 240 may manage channel state information related to a service, which is provided from each of broadcast channels of the plurality of broadcasts, and subscriber channel information representing a utilization state of a broadcast channel at each of the plurality of subscriber terminals.

The channel state information may include service type information representing whether a service for each of the broadcast channels is provided in the form of a real time broadcast, a service state information representing whether a service is currently being provided at each of the broadcast channels and a serviced subscriber number information representing the number of subscriber terminals being receiving the same channel of each of the broadcast channels. The subscriber channel information may include previous channel information representing a broadcast channel having been previously watched at each of the subscriber terminals and current channel information representing a broadcast channel which is being watched or is requested for watching at each of the subscriber terminals.

The channel information analysis unit 250 analyzes the broadcast channel information of a plurality of broadcasts that are received through the broadcast reception unit 230. For example, the channel information analysis unit 250 analyzes which broadcast provider has provided the broadcast channel of the received broadcast, whether a real time broadcast is provided and whether the broadcast channel provides VOD services or data services, and transmits the result of analysis to the channel information managing unit 220.

The broadcast distribution unit 260 receives broadcasts, which have been requested by each of the subscriber terminals 150 and 160, from the broadcast reception unit 230 and distributes the received broadcasts. The broadcast distribution unit 260 may include a broadcast information copying unit 262. If the channel information managing unit 210 determines whether a plurality of subscriber terminals requesting the same real time broadcast channel of a plurality of broadcasts exit, the broadcast information copying unit 262 copies broadcast information about the same real time broadcast channel and distributes the copied broadcast information to the subscriber terminals having requested the same real time broadcast channel.

In addition, if channel request information is received from a first subscriber terminal, the channel information managing unit 240 checks whether a channel, which is requested by the channel request information, is a real time broadcast channel being provided to a second subscriber terminal, by use of the channel state information. If the requested channel is a real time broadcast channel being provided to a second subscriber terminal, the channel information managing unit 240 allows the broadcast information copying unit 262 to copy broadcast information about the real time broadcast channel being provided to the second subscriber terminal and provide the first subscriber terminal with the copied broadcast information. In addition, if the channel requested by the channel request information is a real time broadcast channel, the channel information managing unit 240 updates the current channel information by use of information about the requested channel.

In distributing the received broadcasts to the subscriber terminals 150 and 160 through the IP network, if the received broadcast information is CATV broadcast information or terrestrial broadcast information, the broadcast distribution unit 260 may convert the received CATV broadcast information or terrestrial broadcast information to a broadcast packet in the form of an IPTV packet, and transmits the converted broadcast packet to the subscriber terminal.

The configuration of the integrated broadcast distribution apparatus 140 shown in FIG. 2 is illustrative purpose only. The internal configuration of the integrated broadcast distribution apparatus 140 may be implemented into various examples. For example, the channel request analyzing unit 210, the channel information managing unit 240 and the channel information analyzing unit 250 may be integrated. In addition, the broadcast information copying unit 262 may be provided as a separate unit from the broadcast distribution unit 260.

According to the integrated broadcast distribution apparatus 140, the subscriber terminal may watch all of the CATV broadcast, the IPTV broadcast and the real time terrestrial broadcast beyond a limitation of channel selection. In distributing a real time terrestrial broadcast according to this example of the integrated broadcast distribution apparatus, broadcast channels are directly received and distributed, thereby reducing traffic load in a network and thus saving bandwidth. In addition, if broadcast information about a CATV broadcast channel or an IPTV broadcast channel is being serviced to a subscriber terminal, the same broadcast packet may be copied and transmitted to a plurality of subscriber terminals. Therefore, the reduced transmission time and the saving of bandwidth along with the above transmission scheme improve the quality of services and reduce the cost for investment in equipment. In addition, the CATV and IPTV broadcast service providers save the connection cost for individual lines extending to the subscriber end points and the installation cost for a set top box.

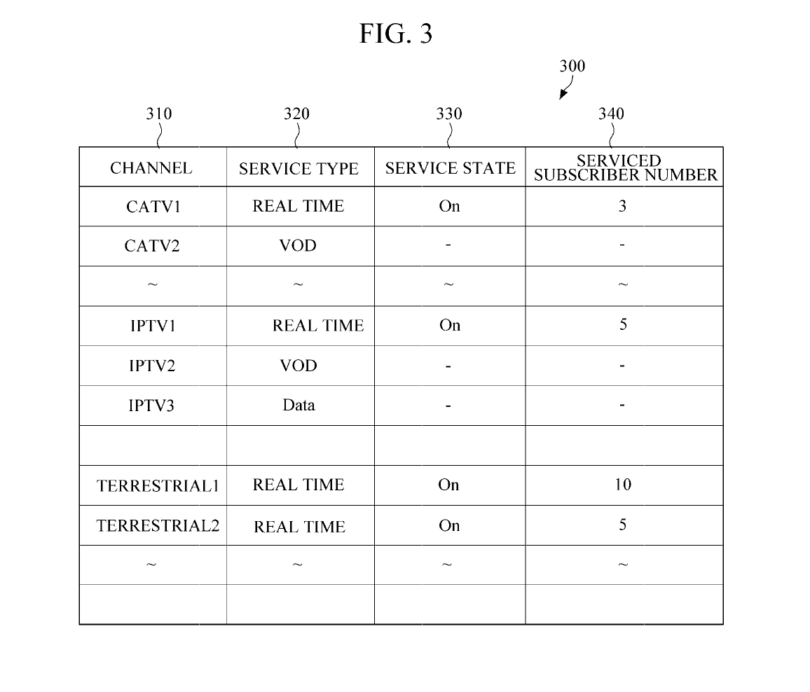

FIG. 3 is a diagram illustrating an example of the configuration of channel state information that is managed by a channel information manager 240 of FIG. 2.

The channel state information 300 may include a plurality of pieces of channel information 310, service type information 320 for each of the plurality of pieces of channel information 310, service state information 330 for each of the plurality of pieces of channel information 310 and a serviced subscriber number information 340 for each of the plurality of pieces of channel information 310.

The service type information represents whether a service for each of the broadcast channels is provided in the form of a real time broadcast. The service type information 320 may include a ‘Real Time’ state, a ‘vOD’ state and a ‘Data’ state.

The ‘Real time’ state represents a case in which the subscriber terminals watch the same content at the same time through the CATV, the IPTV and the terrestrial TV. That is, a channel having service type information of the ‘Real Time’ state represents a channel having features of a terrestrial TV.

A channel having service type information 320 of a ‘vOD’ state or a ‘Data’ state represents a two way service channel that is provided on demand of a subscriber terminal. In this case, the subscriber terminals watch different contents at a predetermined point of time, and the subscriber terminals form a point-to-point type session in cooperation with the broadcast providers. If broadcast channel has service type information 320 of ‘vOD’ state or ‘Data’ state, the integrated broadcast distribution apparatus 140 does not provide a service of copying broadcast information from the integrated broadcast distribution apparatus 140 and distributing the copied broadcast information.

The service state information 330 represents whether a service is currently being provided at a predetermined broadcast channel. If the service state information 330 is in an ‘On’ state, a broadcast service is being provided at a corresponding channel.

The serviced subscriber number information 340 represents the number of subscriber terminals being watching the same channel.

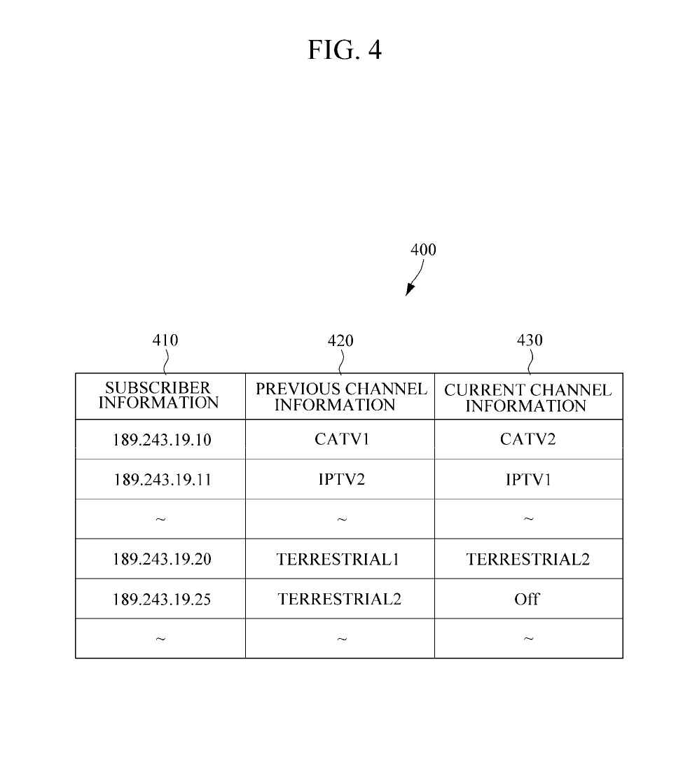

FIG. 4 is a diagram illustrating an example of the configuration of subscriber channel information that is managed by the channel information manager of FIG. 3.

The subscriber channel information 400 shown in FIG. 4 represents channel information serviced at each of the subscriber terminals. The subscriber channel information 400 includes subscriber terminal information 410, previous channel information 420 for the subscriber terminal information 410 and current channel information 430 for the subscriber terminal information 410. The previous channel information represents a broadcast channel having been previously watched for each of the subscriber terminals, and the current channel information represents a broadcast channel which is being watched or is requested for watching for each of the subscriber terminals.

When viewed the subscriber channel information 400, if channel information is changed for each subscriber terminal, channel information recorded on the current channel information 430 becomes the previous channel information 420, and the current channel information 430 is updated by use of the changed channel information. In addition, if channel request information for requesting a predetermine channel is received from a predetermined subscriber terminal and a channel requested by the channel request information is a real time broadcast channel, the current channel information is updated by use of the requested channel information.

The current channel information 430 is used to copy broadcast information or a broadcast packet and transmit the copied information to a subscriber terminal having requested the same real time information. The current channel information 420 indicates an ‘OFF’ state if a subscriber terminal does not watch a broadcast channel.

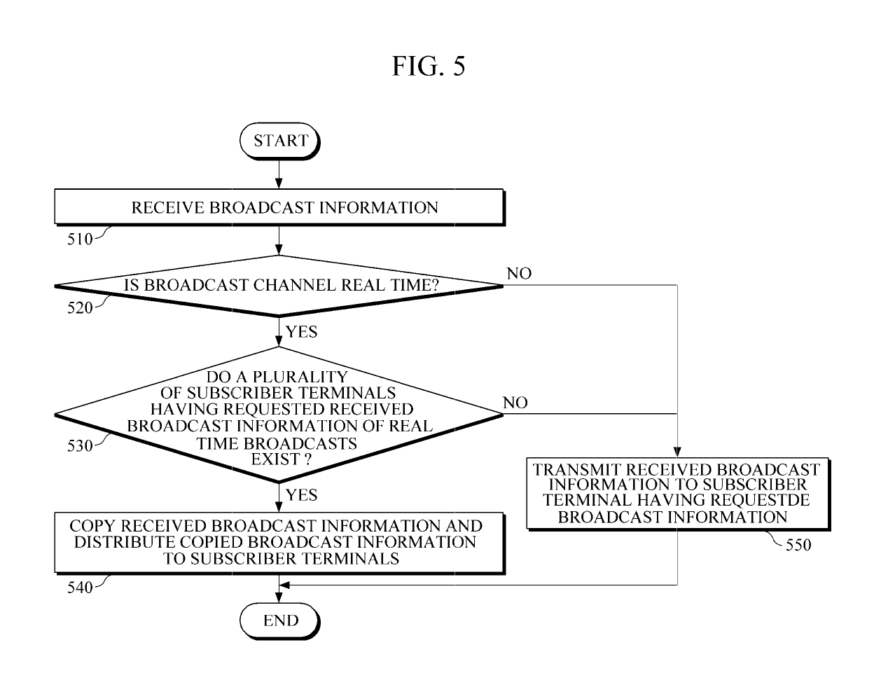

FIG. 5 is a control flow illustrating an example of the control flow of a method for is distributing integrated broadcasts.

As shown in FIGS. 2 and 5, the integrated broadcast distribution apparatus 140 receives a plurality of pieces of broadcast information that are received from a plurality of broadcast providers (510). The integrated broadcast distribution apparatus 140 receives a plurality of pieces of broadcast information depending on a broadcast channel request of each of the subscriber terminals that are registered in the integrated broadcast distribution apparatus 140.

The integrated broadcast distribution apparatus 140 checks the existence of real time broadcast channels of a plurality of broadcasts (520).

The integrated broadcast distribution apparatus 140 checks to determine whether a plurality of subscriber terminals requesting the same real time broadcast channel among the checked real time broadcast channels exist (530).

If the result of checking is that a plurality of subscriber terminals requesting the same real time broadcast channel among the checked real time broadcast channels exist in operation 530, broadcast information about the same real time broadcast channel is copied and the copied broadcast information is distributed to the subscriber terminals having requested the same broadcast channel (540).

If the result of checking is that real time broadcast channels of a plurality of broadcasts do not exist in operation 520, received broadcast information is transmitted to a subscriber terminal having requested the broadcast information (550). In addition, if the result of checking is that a plurality of subscriber terminals requesting the same real time broadcast channel among the checked real time broadcast channels do not exist in operation 530, the integrated broadcast distribution apparatus 140 transmits received broadcast information to a subscriber terminal having requested the broadcast information (550).

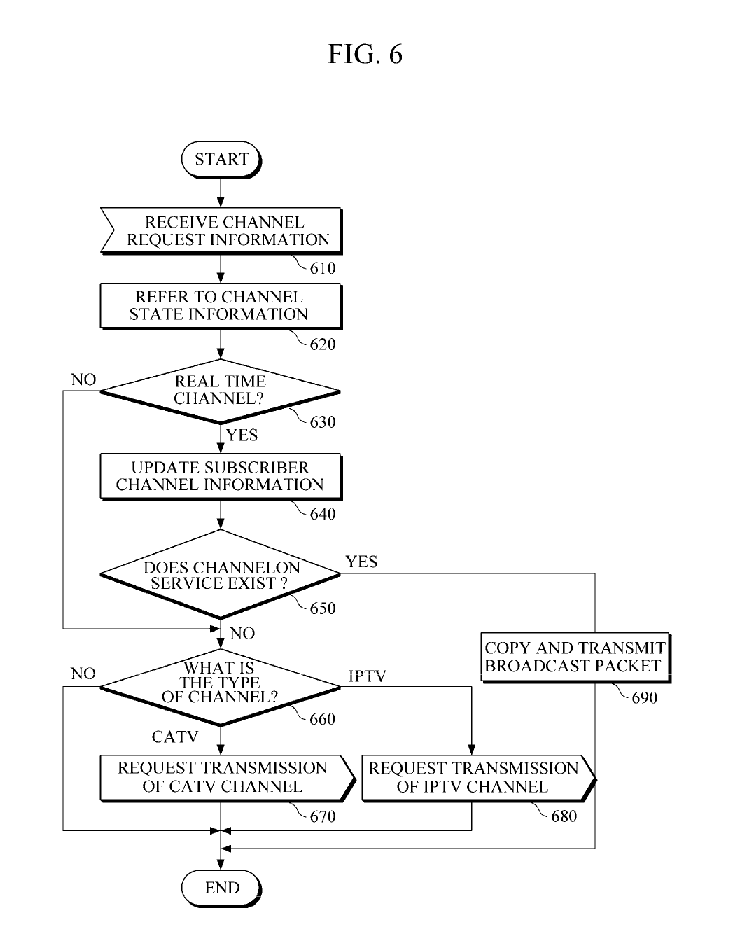

FIG. 6 is a control flow illustrating an example of the operation of the integrated broadcast distributing apparatus upon reception of a request for channel by a subscriber terminal.

If a channel system receives channel request information or a channel request packet from subscriber terminals (150 and 160 in FIG. 1) being in an operating state (610), the channel request analyzing unit 210 analyzes the channel request information. The channel information managing unit 240 refers to channel state information (see FIG. 3) (620) to check whether a channel, which is requested by the channel request information, is a real time broadcast channel (630).

If the channel requested by the channel request information is a real time broadcast channel, the channel information managing unit 240 updates the subscriber channel information shown in FIG. 4 (640). In detail, channel information, which is recorded on the current channel information, is changed to the previous channel information, and the current channel information is updated by use of the requested broadcast channel information.

The channel information managing unit 240 checks whether the requested channel is a broadcast channel, which is currently providing a service, by checking the subscriber channel information (650).

The result of checking that the requested channel is a broadcast channel currently providing a service in operation 650 indicates broadcast information of the corresponding broadcast channel is being received by the broadcast reception unit 230. Accordingly, the broadcast distribution unit 260 copies the received broadcast information according to the control of the channel managing unit 240, and transmits the copied broadcast information to a subscriber terminal, which has transmitted the channel request information, by use of the updated channel information (690), thereby completing the operation of the integrated broadcast distribution apparatus. That is, if a requested channel is being broadcast, in the middle of receiving of broadcast information by the broadcast reception unit 230, the broadcast distribution unit 260 may copy a broadcast packet corresponding to the broadcast information and transmit all subscriber terminals having requested the corresponding broadcast channel.

If the result of checking is that the channel requested in the channel request information is not being currently broadcast in operation 650, the channel information managing unit 240 identifies requested channels according to types (660).

According to the control operation of the channel information managing unit 240, the channel request transmission unit 220 transmits a request for a CATV broadcast channel through a CATV network, if a requested broadcast channel is a CATV channel (670), and transmits a request for an IPTV broadcast channel through an internet network if a requested broadcast channel is an IPTV channel (680). Terrestrial TV broadcast information is directly received to the broadcast reception unit 232. Accordingly, a process of requesting a channel from a broadcast service provider is not required if a requested broadcast channel is a terrestrial TV broadcast channel.

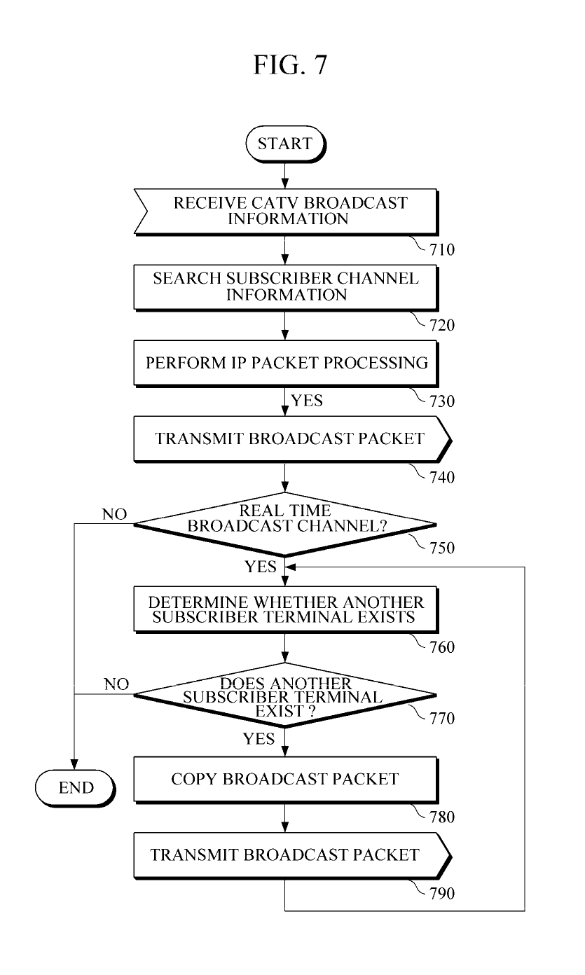

FIG. 7 is a diagram illustrating an example of a process in which broadcast information is received from a CATV broadcast provider and the received broadcast information is provided to a subscriber terminal.

As shown in FIGS. 2 and 7, if the CATV broadcast reception unit 234 receives CATV broadcast information from the CATV broadcast provider 120 as a result of a request for CATV channel (710), the channel information analyzing unit 250 analyzes channel information of the received broadcast and the channel information managing unit 240 determines a subscriber terminal, which has requested the broadcast channel, by searching the subscriber channel information by use of the analyzed channel information (720).

The broadcast distribution unit 260 converts the CATV broadcast information to a broadcast packet in the form of an IP packet (730). The broadcast distribution unit 260 transmits the converted broadcast packet to the subscriber terminal having requested the corresponding CATV channel (740).

In this case, the channel information managing unit 240 checks whether the received broadcast channel is a real time broadcast channel by referring to the channel state information (750). If the received broadcast channel is a real time broadcast channel, the received broadcast channel needs to be transmitted to another subscriber terminal being serviced. Accordingly, the subscriber channel information is searched to determine whether another subscriber terminal exists (760).

If another subscriber terminal having requested the received broadcast channel exists (770), the broadcast distribution unit 260 copies the broadcast packet (780) and transmits the copied broadcast packet to the subscriber terminal (790). The procedure including operations 760, 770, 780 and 790 continue until a subscriber terminal having requested the corresponding broadcast channel is not found from the subscriber channel information.

If the result of checking is that the received CATV broadcast channel is not a real time broadcast channel in operation 750 or a subscriber terminal having requested the same channel is not found in operations 760 and 770, the operation of the integrated broadcast distribution apparatus ends.

In FIG. 7, a procedure including finding of a subscriber terminal having requested the same broadcast channel in operation 760 and copying and transmitting of the broadcast packet in operations 780 and 790 only if the corresponding subscriber terminal has been found in operation 770 is repeated. However, different from FIG. 7, all subscriber terminals having requested the received CATV broadcast channel may be found in operation 760, a predetermined number of broadcast packets corresponding to the found subscriber terminals may be copied in operation 780 and finally the broadcast packets may be simultaneously transmitted to all of the found subscriber terminals in operation 790.

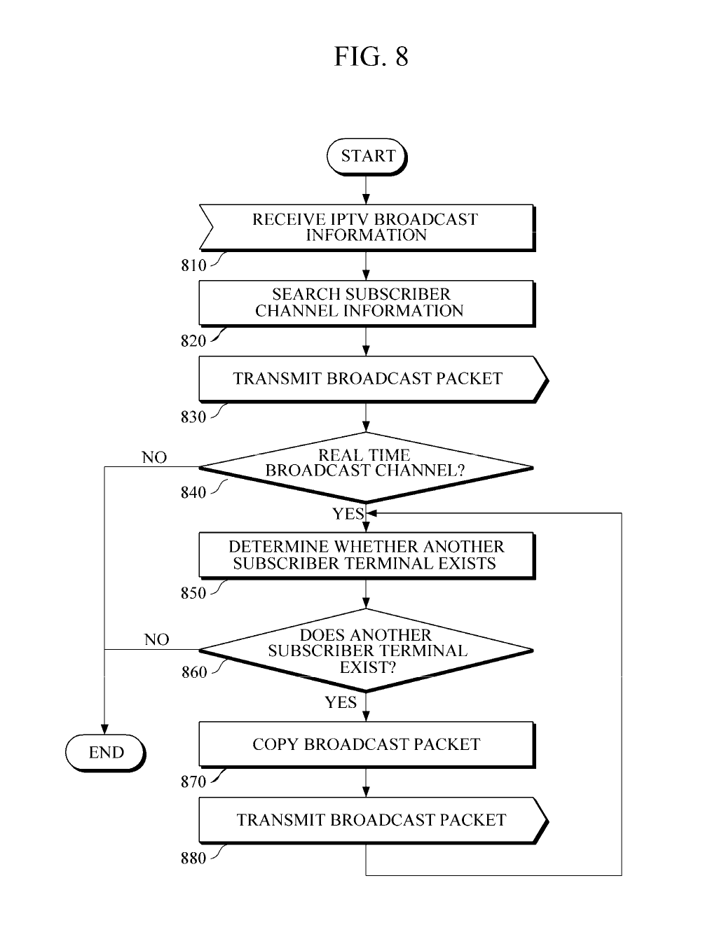

FIG. 8 is a diagram illustrating an example of a process in which broadcast information is received from an IPTV broadcast provider and the received broadcast information is provided to a subscriber terminal.

As shown in FIGS. 2 and 8, if the IPTV broadcast reception unit 236 receives IPTV broadcast from the IPTV broadcast provider 130 as a result of a request for IPTV channel (810). IPTV broadcast information may be an IP packet.

The channel information analyzing unit 250 analyzes channel information of the received broadcast and the channel information managing unit 240 determines a subscriber terminal, which has requested the broadcast channel, by searching the subscriber channel information by use of the analyzed channel information (820), and transmits the broadcast packet to the subscriber terminal having requested the corresponding IPTV channel (830).

The channel information managing unit 240 checks whether the received broadcast channel is a real time broadcast channel by referring to the channel state information (840). If the received broadcast channel is a real time broadcast channel, the received broadcast channel needs to be transmitted to another subscriber terminal being serviced. Accordingly, the subscriber channel information is searched to find out another subscriber terminal (850), and determines whether the other subscriber terminal exists (860).

If the result of the determination is that another subscriber terminal exists in operation 860, the broadcast distribution unit 260 copies the broadcast packet (870) and transmits the copied broadcast packet to the subscriber terminal (880). The procedure including operations 850, 860, 870 and 880 continue until a subscriber terminal having requested the corresponding broadcast channel is not found any more from the subscriber channel information.

In FIG. 8, the procedure including finding of a subscriber terminal having requested the same broadcast channel in operation 850, copying and transmitting of the broadcast packet in operations 870 and 880 only if the corresponding subscriber terminal has been found out in operation 860 is repeated. However, different from FIG. 8, all subscriber terminals having requested the received IPTV broadcast channel may be searched in operation 850, a predetermined number of broadcast packets corresponding to the found subscriber terminals may be copied in operation 870 and the broadcast packets may be simultaneously transmitted to all of the found subscriber terminals in operation 880.

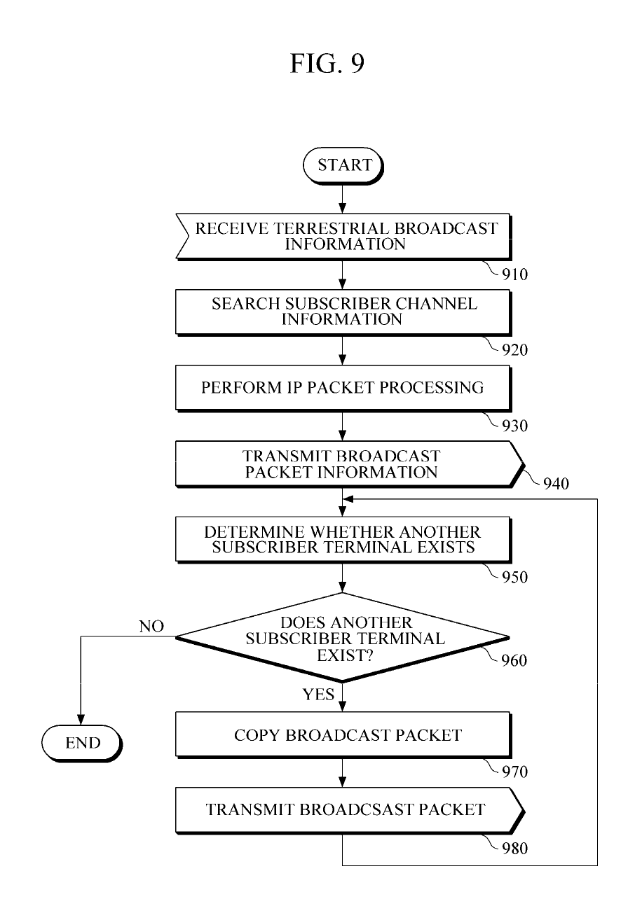

FIG. 9 is a diagram illustrating an example of a process in which broadcast information is received from a terrestrial broadcast provider and the received broadcast information is provided to a subscriber terminal.

As shown in FIGS. 2 and 9, the terrestrial broadcast reception unit 232 receives terrestrial broadcast channel information (910). The channel information analyzing unit 250 analyzes the received broadcast channel information and the channel information managing unit 240 determines a subscriber terminal, which has requested the broadcast channel, by searching the subscriber channel information by use of the analyzed channel information (920).

The broadcast distribution unit 260 converts the terrestrial broadcast information to a broadcast packet in the form of an IP packet (930), and transmits the converted broadcast packet to the subscriber terminal having requested the corresponding terrestrial channel (940).

Since the terrestrial channel needs to be transmitted to another subscriber terminal being serviced in real time. Accordingly, the channel information managing unit 240 finds out another subscriber terminal having requested the corresponding terrestrial broadcast channel by searching the subscriber channel information again (950).

If another subscriber terminal having requested the received broadcast channel exists (960), the broadcast distribution unit 260 copies the broadcast packet (970) and transmits the copied broadcast packet to the other subscriber terminal found in operation 960 (980). The procedure including operations 960, 970 and 980 may continue until a subscriber terminal having requested the corresponding broadcast channel is not found from the subscriber channel information.

In FIG. 9, the procedure including finding of a subscriber terminal having requested the same broadcast channel in operation 950, and copying and transmitting of the broadcast packet in operations 970 and 980 only if the corresponding subscriber terminal has been found out in operation 960 is repeated. However, different from FIG. 9, all subscriber terminals having requested the received terrestrial broadcast channel may be searched in operation 950, a predetermined number of broadcast packets corresponding to the found subscriber terminals may be copied in operation 970 and the broadcast packets may be simultaneously transmitted to all of the found subscriber terminals in operation 980.

The disclosure can also be embodied as computer readable codes on a computer readable recording medium. The computer readable recording medium is any data storage device that can store data which can be thereafter read by a computer system.

Examples of the computer readable recording medium include read-only memory (ROM), random-access memory (RAM), CD-ROMs, magnetic tapes, floppy disks, optical data storage devices, and carrier waves such as data transmission through the Internet. The computer readable recording medium can also be distributed over network coupled computer systems so that the computer readable code is stored and executed in a distributed fashion.

Also, functional programs, codes, and code segments for accomplishing the present invention can be easily construed by programmers skilled in the art to which the present invention pertains. A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An integrated broadcast distributing apparatus for distributing a plurality of broadcasts, which are received from a plurality of broadcast providers, to subscriber terminals, the apparatus comprising:
a broadcast receiving unit configured to receive a plurality of pieces of broadcast information about the plurality of broadcasts;
a channel information managing unit configured to check an existence of a plurality of subscriber terminals of the subscriber terminals requesting a same real time broadcast channel of the plurality of broadcasts; and
a broadcast distribution unit configured to copy broadcast information corresponding to the same real time broadcast channel and distribute the copied broadcast information corresponding to the same real time broadcast channel to the subscriber terminals requesting the same real time broadcast channel, if a result of the checking is that the plurality of subscriber is terminals requesting the same real time broadcast channel exist.

2. The apparatus of claim 1, wherein the channel information managing unit manages channel state information, which is related to a broadcast service of each of broadcast channels of the plurality of broadcasts, and subscriber channel information, which represents utilization state of a broadcast channel used at each of the plurality of subscriber terminals.

3. The apparatus of claim 2, wherein the channel state information comprises service type information representing whether a service for each of the broadcast channels is provided in the form of a real time broadcast, a service state information representing whether a service is currently being provided at a predetermined broadcast channel and a serviced subscriber number information representing the number of subscriber terminals being receiving a same channel of each of the broadcast channels.

4. The apparatus of claim 2, wherein, if channel request information is received from a first subscriber terminal, the channel information managing unit checks whether a channel, which is requested by the channel request information, is a real time broadcast channel, which is being provided to a second subscriber terminal, by use of the channel state information, and
if the requested channel is the real time broadcast channel being provided to the second subscriber terminal, the broadcast distribution unit copies broadcast information corresponding to the real time broadcast channel being provided to the second subscriber terminal and provides the first subscriber terminal with the copied broadcast information.

5. The apparatus of claim 4, wherein the subscriber channel information includes previous channel information representing a broadcast channel having been previously watched is at each of the subscriber terminals and a current channel information representing a broadcast channel, which is being watched or is requested for watching at each of the subscriber terminals, and
if the requested channel is a real time broadcast channel, the channel information managing unit updates the current channel information by use of information about the requested channel.

6. The apparatus of claim 1, wherein if the subscriber terminal is connected to the integrated broadcast distributing apparatus through an internet protocol (IP) network, and the broadcast received broadcast information is cable television (CATV) broadcast information or terrestrial broadcast information, the broadcast distribution unit converts the CATV broadcast information or the terrestrial broadcast information into an IP packet and transmits the converted IP packet to the subscriber terminal.

7. The apparatus of claim 1, further comprising a channel request transmitting unit configured to request broadcast information about a channel, which is requested by the subscriber terminal, to at least one of a CATV broadcast provider or an IPTV broadcast provider.

8. The apparatus of claim 1, wherein the broadcast receiving unit comprises a terrestrial broadcast receiving unit, a CATV broadcast receiving unit and an IPTV broadcast receiving unit.

9. An integrated broadcast distributing method for distributing a plurality of broadcasts received from a plurality of broadcast providers to subscriber terminals, the method comprising:
receiving broadcast information about the plurality of broadcasts;
checking an existence of real time broadcast channels in the plurality of broadcasts;
checking an existence of a plurality of subscriber terminals of the subscriber terminals requesting a same real time broadcast channel of the checked real time broadcast channels; and
copying broadcast information corresponding to the same real time broadcast channel and distributing the copied broadcast information corresponding to the same real time broadcast channel to the subscriber terminals requesting the same real time broadcast channel, if it is checked that the plurality of subscriber terminals requesting the same real time broadcast channel exist.

10. The method of claim 9, further comprising managing channel state information including service type information representing whether a service for each of the broadcast channels is provided in the form of a real time broadcast, a service state information representing whether a service is currently being provided at a predetermined broadcast channel and a serviced subscriber number information representing the number of subscriber terminals being receiving the same channel at each of the broadcast channels.

11. The method of claim 10, wherein the checking of the existence of a plurality of subscriber terminals requesting the same real time broadcast channel is performed by use of the channel state information.

12. The method of claim 10, further comprising managing the subscriber channel information including previous channel information representing a broadcast channel having been previously watched at each of the subscriber terminals and a current channel information representing a broadcast channel which is being watched or is requested for watching at each of the subscriber terminals; and
in the copying of broadcast information corresponding to the same real time broadcast channel and distributing of the copied broadcast information, the distribution is performed by use of the subscriber channel information that includes the previous channel information and the current channel information is used.

13. The method of claim 12, further comprising:
receiving channel request information from a first subscriber terminal;
checking whether a channel, which is requested by the channel request information, is a real time broadcast channel, which is being provided to a second subscriber terminal, by use of the channel state information;
if the requested channel is the real time broadcast channel being provided to the second subscriber terminal, copying broadcast information, which corresponds to the real time broadcast channel being provided to the second subscriber terminal; and
providing the first subscriber terminal with the copied broadcast information.

14. The method of claim 13, further comprising, if the channel requested in the channel request information is a real time broadcast channel, updating the current channel information by use of information about the requested channel.

15. The method of claim 14, further comprising, upon reception of broadcast information corresponding to a real time broadcast channel, checking whether another subscriber terminal, which requests the real time broadcast channel at a point of time corresponding to the reception of the broadcast information by using the updated current channel information, exists; and
if a result of the checking is that another subscriber terminal requesting the real time broadcast channel at the point of time corresponding to the reception of the broadcast information exists, copying the received broadcast information and transmitting the copied broadcast information to another subscriber terminal.

16. An integrated broadcast distributing method for distributing a plurality of broadcasts received from a plurality of broadcast providers to a plurality of subscriber terminals, the method comprising:
receiving cable television (CATV) broadcast information;
converting the CATV broadcast information to a broadcast packet in the form of an Internet Protocol (IP) packet;
determining a first subscriber terminal, which has requested the CATV broadcast information, by searching subscriber channel information including current channel information representing a broadcast channel, which is being watched or is requested for watching, at each of the subscriber terminals;
transmitting the broadcast packet to the determined first subscriber terminal;
searching to determine whether a second subscriber terminal, which has requested the CATV broadcast information, exists, if the received CATV broadcast information is broadcast information corresponding to a real time broadcast channel;
copying the broadcast packet if a result of the searching is that the second subscriber terminal having requested the CATV broadcast information exists; and
transmitting the copied broadcast packet to the second subscriber terminal.

17. The method of claim 16, further comprising:
receiving CATV broadcast request information from a third subscriber terminal;
checking whether a broadcast channel requested by the CATV broadcast request information is a broadcast channel which is being serviced; and
if the requested broadcast channel is a broadcast channel being serviced to a fourth subscriber terminal, copying a broadcast packet being provided to the fourth subscriber terminal and providing the third subscriber terminal with the broadcast packet.

18. An integrated broadcast distributing method for distributing a plurality of broadcasts received from a plurality of broadcast providers to a plurality of subscriber terminals, the method comprising:
receiving Internet Protocol television (IPTV) broadcast information;
determining a first subscriber terminal, which has requested IPTV broadcast information, by searching subscriber channel information including current channel information that represents a broadcast channel which is being watched or is requested for watching at each of the subscriber terminals;
transmitting the IPTV broadcast information to the determined first subscriber terminal;
searching to determine whether a second subscriber terminal, which has requested the IPTV broadcast information, exists, if the received IPTV broadcast information is broadcast information about a real time broadcast channel;
copying the IPTV broadcast information if a result of the searching is that the second subscriber terminal having requested the IPTV broadcast information exists; and
transmitting the copied IPTV broadcast information to the second subscriber terminal.

19. The method of claim 18, further comprising:
receiving IPTV broadcast request information from a third subscriber terminal;
checking whether a broadcast channel requested by the IPTV broadcast request information is a broadcast channel which is being serviced; and
if the requested broadcast channel is a broadcast channel being serviced to a fourth subscriber terminal, copying broadcast information being provided to the fourth subscriber terminal and providing the third subscriber terminal with the copied broadcast information.
